(19) United States
(12) Patent Application Publication
(10) Pub. No.: US 2005/0118320 A1
(43) Pub. Date: Jun. 2, 2005

(54) Method and composition for gel mixture

(75) Inventor: Theresa Doyle, Pearl River, NY (US)

Correspondence Address: GREENBERG-TRAURIG, 1750 TYSONS BOULEVARD, 12TH FLOOR, MCLEAN, VA, 22102, US

(73) Assignee: J. Manheimer, Inc., Teterboro, NJ (US)

(21) Appl. No.: 10/946,348

(22) Filed: Sep. 22, 2004

Related U.S. Application Data
(60) Provisional application No. 60/504,439, filed on Sep. 22, 2003.
(60) Provisional application No. 60/508,881, filed on Oct. 7, 2003.

(51) Int. Cl. A23L 1/05

(52) U.S. Cl. 426/573

(57) ABSTRACT

A quick-gel mixture is prepared from a liquid mixture and a powder blend. The liquid mixture is an alginate blended with sugar and solubilized in water and, optionally, ethyl alcohol. The powder blend is a mix of sugar, calcium, acids, and sodium citrate, which acts as a sequestering agent to control the release of calcium. The acids used are a combination of adipic and glucono delta lactone. The acids being used are slow-release-type acids and control the rate of gelling. The source of calcium is calcium glycerophosphate, which is readily soluble in the liquid phase and reacts with the alginate to form the gel. Granular sugar is used as a carrier and to solubilize the powder blend mix. To prepare the final product, the liquid mixture and the powder blend are combined and shaken for about 15 seconds. The gel sets in approximately 15 to 30 minutes.

This application claims priority from Provisional U.S. Patent Application Ser. No. 60/504,439, filed Sep. 22, 2003, and Provisional U.S. Patent Application Ser. No. 60,508,881, filed Oct. 7, 2003, both of which are hereby incorporated by reference in their entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of a method and composition for a quick-setting edible gel that does not require heating or cooling.

### BACKGROUND OF THE INVENTION

The process for making a conventional gel mold utilizes a packet of a powdered gelatin containing artificial flavors and colors. The powdered gelatin mixture is added to boiling water and stirred for about three minutes, until the mixture has completely dissolved. The boiling water breaks the bonds between the gelatin strands, allowing the polypeptide chains to float in the solution. The heated solution is removed from the heat. Cold water and, optionally, an alcoholic beverage are added. The gelatin mixture must then chill for one to two hours, allowing the polypeptide chains to reassociate. Because this process is so slow and the strands have been widely dispersed through mixing, the chains are unable to reform the original helical shape. Water becomes trapped inside the tangled polypeptide chains, allowing the chains to form a protein net in the shape of the mold and providing the characteristic “jiggle.”

There has long been a desire to provide a gel that would not have to be prepared hours in advance of consumption, but could be made ready for consumption within minutes. Gels are commonly used as a dessert gel or in the form of a “gel shot” having alcohol. Whether the gel is to be prepared by a busy parent, a young child, or a bartender, it is desirable to have a quick-setting gel. The conventional process for producing a gel is limited by its ingredients.

Crystalline gelatin is not soluble in cold water, so the gelatin must be dissolved in boiling water. In order to effect gelation, the solution must then be cooled. Both of the heating and cooling steps increase the total time for preparation of the gel.

It is desirable to eliminate the need to add hot or cold water in the gel process. The use of boiling water is time consuming, dangerous, and may even be unavailable. Waiting for water to boil adds precious minutes to the preparation time. Stirring the gelatin mixture also adds more time to the process. Additionally, stirring hot liquids can be dangerous for a child or an adult. In some locations, such as at a bar or pub, access to boiling water is limited. A bartender may not have access to any boiling water for making gel shots. Furthermore, the use of water requires careful measuring in order to ensure the proper consistency of the gel. A child who does not properly measure the water may be disappointed when a inconsumable gel is formed two hours later.

Conventional attempts to eliminate boiling water from the process have not sufficiently limited the preparation time or ease of preparation. Conventional gel mixtures still require cooling, regardless of whether the gel mixture had been previously heated in boiling water. The cooling stage requires placing the hot mixture in a refrigerated environment for one to two hours. The amount of time required for cooling inhibits a quick-gel process. Additionally, the use of measuring cold water is an inconvenient step in the process. Improperly measuring the amount of cold water may lead to undesirable gelatinous characteristics. Children may not be able to properly measure and bartenders may not have the time or the resources to measure cold water.

### SUMMARY OF THE INVENTION

It is desired to have a quick-setting gel that does not require heating or cooling. Accordingly, the present invention is directed to a method and composition of a quick-gel mixture that substantially obviates one or more of the problems due to limitations and disadvantages of the related art. The product of the present invention is prepared from a liquid mixture and a powder blend. The liquid mixture is an alginate blended with sugar and solubilized in water and, optionally, ethyl alcohol. Coloring and flavorings may also be added. The powder blend is a mix of sugar, calcium, acids, and sodium citrate, which acts as a sequestering agent to control the release of calcium. The acids used are a combination of adipic and glucono delta lactone. Optionally, citric acid is also used. The rate of gelling is determined in part by how quickly the pH of the product is lowered. The acids being used are slow-release-type acids and control the rate of gelling. The source of calcium is calcium glycerophosphate, which is readily soluble in the liquid phase and reacts with the alginate to form the gel. Granular sugar is used as a carrier and to solubilize the powder blend mix. To prepare the final product, the liquid mixture and the powder blend are combined and shaken for about 15 seconds. The gel sets in about 15 to 30 minutes.

In one embodiment, a mixture for producing a gel comprises a first component comprising approximately 68 to 99% water and approximately 0.3 to 0.6% alginate; and a second component comprising approximately 2 to 6% calcium constituent and approximately 6 to 11% calcium sequestering agent; wherein the first and second components are mixed to formed a gel. The alginate is sodium alginate. The first component further comprises an alcohol, which may be ethyl alcohol. The first component further comprises a sugar. The first component further comprises flavoring and/or coloring. The first component further comprises at least one ingredient selected from the group of phosphoric acid, sodium benzoate, and potassium sorbate. The second component further comprises at least one ingredient selected form the group of adipic acid, glucono delta lactone, citric acid, sugar, and zeofree. The calcium constituent is calcium glycerophosphate. The calcium sequestering agent is sodium citrate. The gel is approximately 96 to 97% first component and approximately 3-4% second component.

In another embodiment, a method for producing a gel comprises the steps of mixing a first component having approximately 0.3% to 0.6% alginate with a second component having approximately 2% to 6% calcium constituent to form a gel mixture; and allowing the gel mixture to set. The first component further comprises approximately 68% to 99% water. The alginate is sodium alginate. The first component further comprises at least one ingredient selected from the group consisting of sugar, flavoring, coloring, and alcohol. The first component further comprises at least one ingredient selected from the group of phosphoric acid, sodium benzoate, and potassium sorbate. The second component further comprises at least one ingredient selected form the group of adipic acid, glucono delta lactone, citric acid, sugar, and zeofree. The calcium constituent is calcium glycerophosphate. The gel is approximately 96% to 97% first component and approximately 3% to 4% second component. The method further comprises the step of mixing a calcium sequestering agent with the calcium constituent to form the second component. The calcium sequestering agent is sodium citrate. The second component comprises approximately 6% to 11% calcium sequestering agent.

In yet another embodiment, a method for making a gel comprises the steps of mixing an alginate with water to form a liquid solution; mixing a calcium component and a calcium sequestering agent to form a powder mixture; combining the liquid solution and the powder mixture to form a gel mixture; distributing the gel mixture to at least one container for setting; and allowing the gel mixture to set to form a gel. The liquid solution comprises 68-99% water and 0.3-0.6% alginate. The alginate is sodium alginate. The powder mixture comprises 2-6% calcium component and 6-11% calcium sequestering agent. The calcium component is calcium glycerophosphate. The calcium sequestering agent is sodium citrate.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof.

It is to be understood that both the foregoing general description and the following detailed description are exemplary and explanatory and are intended to provide further explanation of the invention as claimed.

### DETAILED DESCRIPTION OF THE PREFERRED EMBODIMENT

A product according to the present invention can be used for quickly producing an edible gel mixture without heating or cooling. For example, the product is made with alcohol to produce a “gel shot.” The product is comprised of two components.

The first component is a liquid mixture comprising an alginate, which is a gelling agent. Preferably, the alginate is sodium alginate. When mixed with calcium, sodium alginate forms a gel without heating. The alginate is blended with sugar and the mixture is solubilized in water. Optionally, ethyl alcohol or other alcohol or beverage may be incorporated for flavor, color, or to increase the alcohol content. Coloring and flavorings may also be added.

The manufacturing process of the liquid mixture with alcohol is as follows. Measured amounts of water and ethyl alcohol are added to a container. The water and ethyl alcohol are mixed using a lightnin mixer for approximately 10 minutes, until the liquid ingredients are uniformly mixed in the liquid. The alginate and sugar are slowly added to the liquid ingredients. The liquid mixture comprises approximately 0.3% to 0.6% alginate and approximately 68% to 99% water. The lightnin mixer continues to mix all of the ingredients as the gelling agent and sugar are added. The ingredients are mixed for approximately 15 minutes or until the dry ingredients are substantially incorporated in the solution.

The liquid mixture is stored in a sealable container, such as one having a cap, or other similar container known to one of ordinary skill in the art. The container storing the liquid mixture does not need to be refrigerated.

The manufacturing process of the liquid mixture without alcohol is as follows. Measured amounts of water, alginate, and sugar are added to a tank. The liquid mixture comprises approximately 0.3% to 0.6% alginate and approximately 68% to 99% water. Additionally, preservatives and an acid are added to the non-alcohol liquid mixture. Preferably, the acid is phosphoric acid. The lightnin mixer mixes the ingredients for approximately 10 minutes or until substantially uniform.

The second component is a powder blend comprising a mixture of sugar, acids, calcium, and a sequestering agent. Granular sugar is used as a carrier and to solubilize the powder blend mix.

An acid is included in the powder blend to assist with the adjustment of the pH of the mixture. Preferably, the acid is a slow-release-type acid, such as adipic acid and glucono delta lactone (“GDL”). Food grade adipic acid is used to promote rapid setting and provide a tart taste. A gel has desirable physical properties and taste when the pH is between approximately 3.8 and 4.0. Adipic acid and GDL assist in controlling the rate at which the pH is lowered. In the non-alcohol liquid mixture, citric acid is also added.

The powder blend has a calcium constituent that forms a gel when mixed with the alginate of the liquid mixture. Preferably, the source of calcium is calcium glycerophosphate, which is readily soluble in the liquid phase. The powder blend comprises approximately 2 to 6% calcium glycerophosphate. GIVOCAL is a source of calcium glycerophosphate, produced by Seppic, Inc., of Fairfield, N.J. At higher calcium levels, a gel results from permanent associations of the chains between the calcium and the alginate. Low levels of calcium result in temporary associations, giving rise to highly viscous, thixotropic solutions. The rate at which the calcium is made available to the alginate molecules depends primarily on pH and the quantity, particle size, and solubility of the calcium. A smaller particle size and lower pH favor a rapid release of calcium.

In order to slow the release of calcium during the mixing of the two components, a calcium sequestrant is added. The calcium sequestrant controls the reaction by competing with the alginate by binding the calcium ions. The powder blend comprises approximately 6% to 11% calcium sequestrant. Preferably, the calcium sequestrant is sodium citrate. However, other types of calcium sequestrants may be used. Increasing the amount of calcium sequestrant decreases the setting rate of the gel. Because the calcium ions favor the sequestrant over the alginate, the sequestrant is used in limited amounts during the mixing process to prevent premature gelation or an irreversible breakdown of the gel structure. When the alginate, calcium, and sequestrant are mixed rapidly and efficiently, a quick-setting gel forms with the desired structural integrity.

The powder blend is stored in a sealable container. Preferably, the powder blend is stored in a packet such as those used for sugar. Because the amount of the powder blend needed is relatively small, the packet is designed for a single use.

The first and second components are combined in a container. Preferably, the second component is added to the container holding the first component. The container is then mixed for approximately fifteen seconds, until the gel mixture is sufficiently combined. Mixing may be accomplished by shaking the container or using a mixing apparatus known to one of ordinary skill in the art. The gel mixture of the first and second components is optionally poured into a mold, cups, shot glasses, or other containers. In approximately 15 to 30 minutes, the gel mixture is set and is ready for consumption.

The invention is further described but not limited by the following examples.

### EXAMPLE 1

Raspberry Flavored Gel Mixture

In an exemplary embodiment wherein alcohol is incorporated in the gel mixture, a 30 proof gel shot is prepared having a raspberry flavor. A raspberry gel base has the following ingredients:

| Ingredient | Parts By Weight |
|---|---|
| Water | 70.15 |
| Ethyl Alcohol | 16.32 |
| Raspberry Flavor/Color | 0.55 |
| Gelling Agent Powder | 12.98 |

The water, 190 proof ethyl alcohol, and natural raspberry with 0. 1% artificial and certified color is mixed for approximately 10 minutes in a tank with a lightnin mixer. The gelling agent powder is slowly added. The gelling agent powder comprises the following ingredients:

| Ingredient | Parts By Weight |
|---|---|
| Fine Granular Sugar | 96.456 |
| Keltone HV Sodium Alginate | 3.344 |
| ZEOFREE | 0.200 |

The gelling agent powder comprises Keltone HV sodium alginate, which is a fine-mesh, medium-gel-strength sodium alginate with high viscosity. The gelling agent powder also comprises ZEOFREE, a silicon dioxide produced by J. M. Huber Corp. of Havre de Grace, Md., that assists with the storage stability of the gelling agent powder.

The lightnin mixer continues to mix for approximately 15 minutes when the gelling agent powder is added. Mixing is complete when the gelling agent powder is in solution. The gel base is stored in a container having a removable cap.

A powder blend for gelling comprises the following ingredients:

| Ingredient | Parts By Weight |
|---|---|
| Fine Granular Sugar | 61.25 |
| Glucono Delta Lactone | 24.38 |
| Sodium Citrate | 6.56 |
| Adipic Acid | 4.69 |
| GIVOCAL | 2.81 |
| ZZEOFREE | 0.31 |

The powder blend is a mixture of these dry ingredients and stored in a sealable pouch or packet. The sodium citrate is an anhydrous FG powder.

A gel mixture is prepared by mixing the gel base and the powder blend according to the following proportions:

| Ingredient | Parts By Weight |
|---|---|
| Gel Base | 96.8 |
| Powder Blend for Gelling | 3.2 |

The powder blend is removed from the packet. The cap of the gel base container is removed and the powder blend is poured into the gel base. The cap is secured to the container and the container is vigorously shaken for approximately fifteen seconds or until the powder blend has been incorporated into the gel base. The cap is removed from the container and the gel mixture is poured into jigger-sized glasses. The gel mixture sets-in approximately 15 minutes and is ready for consumption.

### EXAMPLE 2

Strawberry Flavored Gel Mixture

In a second exemplary embodiment, a gel product has a strawberry flavor. A gel base comprises a mixture of the following ingredients:

| Ingredient | Parts By Weight |
|---|---|
| Water | 81.29 |
| Fine Granular Sugar | 18.05 |
| Keltone HV Sodium Alginate | 0.57 |
| Phosphoric Acid | 0.05 |
| Sodium Benzoate | 0.03 |
| Potassium Sorbate | 0.01 |

The corn syrup is a high fructose corn syrup (76 Brix). The phosphoric acid is phosphoric acid (85%) NF/FCC grade kosher. The sodium benzoate (18%) is a food preservative and used at low levels to prevent an unacceptable aftertaste. Potassium sorbate is also included as a food preservative.

The gel base and the natural and artificial strawberry flavorings and coloring are mixed in a tank with a lightnin mixer for approximately 10 minutes or until uniformly mixed. The strawberry flavorings and coloring is added to the gel base in the follow proportions:

| Ingredient | Parts By Weight |
|---|---|
| Gel Base | 99.68 |
| Strawberry Flavor/Color | 0.32 |

The strawberry flavored gel base is packaged in a container having a removable cap.

A powder blend for gelling comprises the following ingredients mixed together and stored in a sealable pouch or packet:

| Ingredient | Parts By Weight |
|---|---|
| Fine Granular Sugar | 50.68 |
| Glucono Delta Lactone | 21.36 |
| Sodium Citrate | 10.96 |
| Adipic Acid | 4.94 |
| GIVOCAL | 4.94 |
| ZEOFREE | 0.28 |
| Citric Acid | 6.84 |

A gel mixture is then prepared by mixing the strawberry flavored gel base and the powder blend according to the following proportions:

| Ingredient | Parts By Weight |
|---|---|
| Strawberry Flavored Gel Base | 96.35 |
| Powder Blend for Gelling | 3.65 |

The powder blend is removed from the packet. The cap of the gel base container is removed and the powder blend is poured into the gel base. The cap is secured to the container and the container is vigorously shaken for approximately fifteen seconds or until the powder blend has been incorporated into the gel base. The cap is removed from the container and the gel mixture is poured into cups or molds. The gel mixture sets in approximately 15 minutes and is ready for consumption.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

1. A mixture for producing a gel comprising:
a first component comprising:
approximately 68 to 99% water and approximately 0.3 to 0.6% alginate; and
a second component comprising:
approximately 2 to 6% calcium glycerophosphate and approximately 6 to 11% calcium sequestering agent;
wherein the first and second components are mixed to formed a gel.

2. The mixture of claim 1, wherein the alginate is sodium alginate.

3. The mixture of claim 1, wherein the first component further comprises an alcohol.

4. The mixture of claim 3, wherein the alcohol is ethyl alcohol.

5. The mixture of claim 1, wherein the first component further comprises sugar.

6. The mixture of claim 1, wherein the first component further comprises at least one ingredient selected from the group of phosphoric acid, sodium benzoate, and potassium sorbate.

7. The mixture of claim 1, wherein the second component further comprises at least one ingredient selected form the group of adipic acid, glucono delta lactone, citric acid, sugar, and zeofree.

8. The mixture of claim 1, wherein the calcium sequestering agent is sodium citrate.

9. The mixture of claim 1, wherein the gel is approximately 96 to 97% first component and approximately 3-4% second component.

10. A method for producing a gel, the method comprising the steps of:
mixing a first component having approximately 0.3% to 0.6% alginate with a second component having approximately 2% to 6% calcium glycerophosphate to form a gel mixture; and
allowing the gel mixture to set.

11. The method of claim 10, wherein the first component further comprises water.

12. The method of claim 11, wherein the first component further comprises approximately 68% to 84% water.

13. The method of claim 10, wherein the alginate is sodium alginate.

14. The method of claim 10, wherein the first component further comprises at least one ingredient selected from the group consisting of sugar, flavoring, coloring, and alcohol.

15. The method of claim 10, wherein the first component further comprises at least one ingredient selected from the group of phosphoric acid, sodium benzoate, and potassium sorbate.

16. The method of claim 10, wherein the second component further comprises at least one ingredient selected form the group of adipic acid, glucono delta lactone, citric acid, sugar, and zeofree.

17. The method of claim 10, wherein the gel is approximately 96% to 97% first component and approximately 3% to 4% second component.

18. The method of claim 10, further comprising the step of mixing a calcium sequestering agent with the calcium constituent to form the second component.

19. The method of claim 10, wherein the calcium sequestering agent is sodium citrate.

20. The method of claim 10, wherein the second component comprises approximately 6% to 11% calcium sequestering agent.

21. A method for making a gel, the method comprising the steps of:
mixing an alginate with water to form a liquid solution;
mixing a calcium component and a calcium sequestering agent to form a powder mixture;
combining the liquid solution and the powder mixture to form a gel mixture;
distributing the gel mixture to at least one container for setting; and
allowing the gel mixture to set to form a gel.

22. The method of claim 21, wherein the liquid solution comprises 68-99% water and 0.3-0.6% alginate.

23. The method of claim 21, wherein the alginate is sodium alginate.

24. The method of claim 21, wherein the powder mixture comprises 2-6% calcium component and 6-11% calcium sequestering agent.

25. The method of claim 21, wherein the calcium sequestering agent is sodium citrate.
